(19) United States
(12) Patent Application Publication
(10) Pub. No.: US 2011/0279451 A1
(43) Pub. Date: Nov. 17, 2011

(54) 3D IMAGE CONTROL APPARATUS AND 3D IMAGE CONTROL METHOD

(75) Inventor: Minoru Haga, Kawasaki-shi (JP)

(73) Assignee: CANON KABUSHIKI KAISHA, Tokyo (JP)

(21) Appl. No.: 13/096,369

(22) Filed: Apr. 28, 2011

(30) Foreign Application Priority Data
May 14, 2010 (JP) 2010-112219

(51) Int. Cl. G06T 15/00

(52) U.S. Cl. 345/419

(57) ABSTRACT

A crosstalk image signal is generated by multiplying an image signal in a subsequent display period of a correction target image signal by a coefficient which is set corresponding to a vertical position on a display screen of a display apparatus in a descending order from the top, or multiplying an image signal in a previous display period of the correction target image signal by a coefficient which is set corresponding to the vertical position on the display screen in a descending order from the bottom. Then the crosstalk image signal is subtracted from the correction target image signal.

### BACKGROUND OF THE INVENTION

1. Field of the Invention

The present invention relates to a 3D image control apparatus and a 3D image control method.

2. Description of the Related Art

A frame sequential type 3D image display system for constructing a 3D image (three-dimensional image) by alternately displaying a right eye image and a left eye image, which have parallax so that the left eye and the right eye see different images via shutter glasses, is known (see Japanese Patent Application Laid-Open No. 2000-275575). For the shutter glasses, liquid crystal shutter type glasses constituted by a liquid crystal layer and a polarizer is mainly used.

An ideal relationship of a switching timing of shutter glasses and an image display timing in the frame sequential system will be described with reference to FIG. 5A, FIG. 5D and FIG. 5E. FIG. 5A shows a switching timing between the left and the right of the shutter glasses, the ordinate indicates a transmission quantity of the shutter glasses, and the abscissa indicates time. A solid line 12 indicates a switching timing of a left eye shutter, and a dotted line 13 indicates a switching timing of a right eye shutter. It is known that delays due to the response speed of liquid crystals exist in the switching of the shutters. A diagonal portion from “open” to “close” and from “close” to “open” in the solid line 12 and the dotted line 13 indicates delays. FIG. 5D shows the display timings of the left and right images, the ordinate indicates display brightness, and the abscissa indicates time. A solid line 14 indicates brightness of a left eye image, and a dotted line 15 indicates brightness of a right eye image. To simplify explanation, FIG. 5D shows an example of displaying an image having a constant brightness. FIG. 5E shows brightness when a viewer observed an image having the characteristics shown in FIG. 5D via shutter glasses having the characteristics shown in FIG. 5A. The ordinate in FIG. 5E indicates the brightness to be observed. In FIG. 5E, in one field period of time t1 to t4, the left eye shutter is in the open state, and the right eye shutter is in the closed state, hence light 16 of the left eye image transmits only through the left eye shutter. In the subsequent one field period, on the contrary, a light 17 of the right eye image transmits only through the right eye shutter as indicated by the dotted line 13. Therefore the viewer observes only the left eye image with the left eye, and observes only the right eye image with the right eye.

As mentioned above, delays due to the response speed of liquid crystals exist in switching of the shutter of the shutter glasses. FIG. 5B and FIG. 5C show examples of the shutter glasses of which transition time of the shutter from open to close is longer than that in FIG. 5A. In other words, in FIG. 5A, the right eye shutter becomes fully closed at time t1, but the timing to be fully closed delays to time t2 in FIG. 5B, and to time t3 in FIG. 5C. If the display image in FIG. 5D is observed with these shutter glasses, display of the image in the next field is started before the shutter becomes fully closed, as shown in FIG. 5F and FIG. 5G. Then the right eye image 18 is observed with the left eye, and the left eye image 19 is observed with the right eye, and the right eye image and the left eye image appear to be mixed up. This phenomena is called “crosstalk”.

FIG. 6A is an example of a left eye image and a right eye image. FIG. 6B show an example of crosstalk observed in a plane-sequential driving type display apparatus (e.g. liquid crystal display, plasma display). The right eye image, overlapped on the entire left eye image, can be faintly seen. Therefore brightness slightly increases in a background portion 20 in general, and a double image is generated in an object portion 21.

Japanese Patent Application Laid-Open Nos. H8-331600 and 2002-84551 disclose methods for generating a crosstalk correction signal by multiplying a right (left) image signal by a coefficient, and decreasing the crosstalk correction signal from the left (right) image signal, whereby crosstalk in the 3D image is decreased.

After study by the present inventor, it was discovered that crosstalk which looks different from a plane-sequential driving type display apparatus appears in a case of a multiplex driving type display apparatus (e.g. field emission display).

In the case of a multiplex driving system, an image is displayed one line at a time from a line 24 at the highest portion of the screen to a line 25 at the lowest portion of the screen in one field period (time t1 to time t4), as shown in FIG. 7 (the lower figure shows a view of the upper figure enlarged in the time direction). For example, in a case of an HDTV image signal, 1080 lines exist in one field period. If a close timing of a shutter delays like the case of FIG. 5B and FIG. 5C, an image 22 of the other eye (called cross talk image) is faintly observed only in an upper portion of the screen, as shown in FIG. 6C. The brightness of this crosstalk image 22 gradually decreases while descending from the highest portion of the screen, and becomes zero in the middle of the screen. The brightness and range of the crosstalk image 22 increase as the delay of the close timing of the shutter increases. In other words, a wider and brighter crosstalk image is observed via the shutter glasses in FIG. 5C than that in FIG. 5B.

In order to implement a high brightness display, maximizing the display period of each field is normally desired. Therefore in a 3D image display apparatus, in some cases a display period longer than a full transmission period (t1 to t4 in FIG. 5A) of the shutter glasses may be set. FIG. 8A is an example when the full transmission period and the display period match (the same as FIG. 5D), and FIG. 8B and FIG. 8C are examples when the display period is longer than the full transmission period. FIG. 8D to FIG. 8F show brightness that is observed when the images in FIG. 8A to FIG. 8C are observed via the shutter glasses having the characteristics in FIG. 5A. If the display period is longer than the full transmission period, the shutter begins to open during the period of displaying the previous field, as shown in FIG. 8E and FIG. 8F. Therefore the left eye image 26 in the previous field is observed with the right eye, or the right eye image 27 in the previous field is observed with the left eye. FIG. 6D is an example of crosstalk which appears in a multiplex driving type display apparatus. The crosstalk image 23 is faintly observed only in a lower portion of the screen. The brightness of the crosstalk image 23 gradually decreases while ascending from the lowest portion of the screen, and becomes zero in the middle of the screen. In the case of FIG. 8E and FIG. 8F, a wider and brighter crosstalk image is observed in FIG. 8F.

As described above, when a 3D image is displayed on a multiplex driving type display apparatus, crosstalk is partially generated in an upper portion or lower portion of the screen, and the brightness of the crosstalk gradually changes according to the vertical position of the screen. Crosstalk having these characteristics cannot be sufficiently reduced by the above mentioned conventional correction method, and in some cases, makes it impossible to display good 3D images.

In order to prevent the generation of crosstalk, it is possible to sufficiently decrease a display period of each field or an open period of the shutter glasses, so that the open state of the shutter does not overlap with the display period of the previous or subsequent field. In this case, however, the quality of the 3D image may drop due to the decrease of display brightness and the increase of flickers.

### SUMMARY OF THE INVENTION

With the foregoing in view, it is an object of the present invention to provide a technology to decrease the crosstalk that is generated due to the delay of switching of the shutter glasses in a multiplex driving type display apparatus so that a high quality 3D image is displayed.

The present invention in its first aspect provides a 3D image control apparatus which causes a multiplex driving type display apparatus to display a right eye image and a left eye image alternately, including: a correction unit for correcting an image signal to be output to the display apparatus in order to reduce crosstalk which is generated due to delay of switching of shutter glasses and is a phenomena of a part of the right eye image being observed with a left eye, or a part of the left eye image being observed with a right eye, wherein the correction unit generates a crosstalk image signal by multiplying an image signal in a subsequent display period of a correction target image signal by a coefficient which is set corresponding to a vertical position on a display screen of the display apparatus in a descending order from the top, or multiplying an image signal in a previous display period of the correction target image signal by a coefficient which is set corresponding to the vertical position on the display screen in a descending order from the bottom, and subtracts the crosstalk image signal from the correction target image signal.

The present invention in its second aspect provides a 3D image control method executed by a 3D image control apparatus which causes a multiplex driving type display apparatus to display a right eye image and a left eye image alternately, including the steps of: inputting an image signal including the right eye image and the left eye image; and correcting an image signal to be output to the display apparatus in order to reduce crosstalk which is generated due to delay of switching of shutter glasses and is a phenomena of a part of the right eye image being observed with a left eye, or a part of the left eye image being observed with a right eye, wherein in the step of correction, a crosstalk image signal is generated by multiplying an image signal in a subsequent display period of a correction target image signal by a coefficient which is set corresponding to a vertical position on a display screen of the display apparatus in a descending order from the top, or multiplying an image signal in a previous display period of the correction target image signal by a coefficient which is set corresponding to the vertical position on the display screen in a descending order from the bottom, and the crosstalk image signal is subtracted from the correction target image signal.

According to the present invention, the crosstalk that is generated due to the delay of switching of the shutter glasses can be decreased in a multiplex driving type display apparatus, so that a high quality 3D image is displayed.

Further features of the present invention will become apparent from the following description of exemplary embodiments with reference to the attached drawings.

### BRIEF DESCRIPTION OF THE DRAWINGS

FIG. 1 is a block diagram depicting a configuration of a 3D image display system;

FIG. 2A and FIG. 2B show how to generate a crosstalk image signal;

FIG. 3A and FIG. 3B show the result of crosstalk correction;

FIG. 4A and FIG. 4B show examples of characteristic data for crosstalk correction;

FIG. 5A to FIG. 5G show examples of switching timing of the shutter and display timing of the image;

FIG. 6A to FIG. 6D show examples of crosstalk;

FIG. 7 shows one field period of a multiplex driving system enlarged in the time direction; and

FIG. 8A to FIG. 8F are diagrams depicting the generation of crosstalk due to an extension of a display period.

### DESCRIPTION OF THE EMBODIMENTS

The present invention relates to a technology to reduce (correct) crosstalk, which is a phenomena generated when a right eye image (hereafter called “right image”) and a left eye image (hereafter called “left image”) are alternately output, in a multiplex driving type display apparatus. The multiplex driving forms images in one screen by a progressive scanning method, which sequentially switches scan lines addressed in one vertical scanning period without taking any intervals. There are two types of multiplex driving: single line driving which switches one line at a time, and multiline driving which switches a plurality of lines at a time. For the display apparatus, an impulse type display apparatus, such as a field emission display (FED), is appropriate.

The present embodiment will now be described with reference to the drawings.

### (System Configuration)

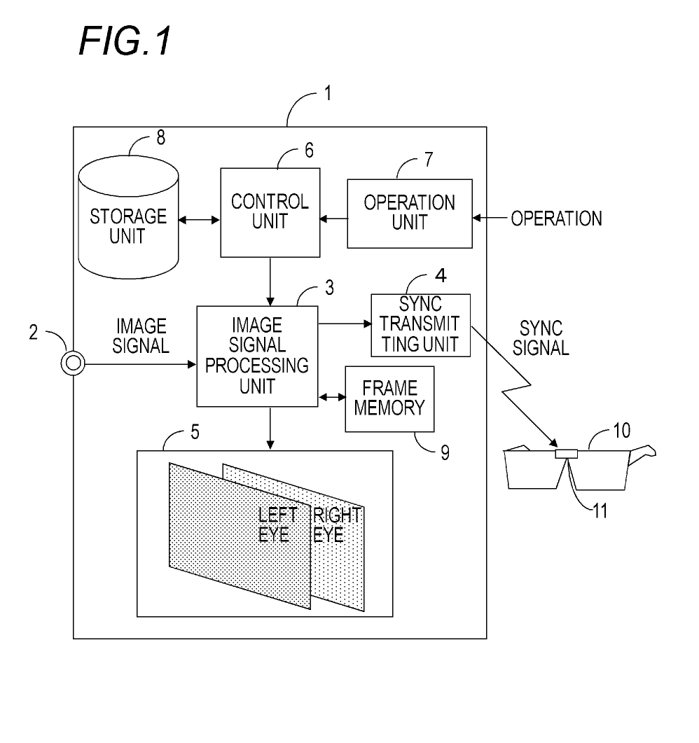

FIG. 1 shows an overview of a configuration of a 3D image display system according to the present embodiment. The 3D image display system is comprised of a 3D image display apparatus 1 and shutter glasses 10. The 3D image display apparatus 1 includes an input terminal 2, an image signal processing unit 3, a sync transmitting unit 4, an image display unit 5, a control unit 6, an operation unit 7, a storage unit 8 and a frame memory 9. The shutter glasses 10 have a sync signal receiving unit 11. In the example of this embodiment, the image display unit 5 corresponds to the multiplex driving type display apparatus, and the functional blocks of the image signal processing unit 3, the control unit 6, the storage unit 8 and the frame memory 9 correspond to the 3D image control apparatus.

In the configuration in FIG. 1, a 3D image signal which is input from the input terminal 2 is separated into a left image signal and a right image signal by the image signal processing unit 3. The image signal processing unit (correction unit) 3 performs the later mentioned crosstalk correction processing on the left image signal and the right image signal, and outputs the corrected left image signal and the corrected right image signal to the image display unit 5. Based on the corrected left image signal and the corrected right image signal, the image display unit 5 displays the left image and the right image alternately (in the sequence of the fields). The image signal processing unit 3 generates a sync signal for shutter glasses, which synchronizes with the display timing of the image display unit 5, and outputs the sync signal for shutter glasses to the sync transmitting unit 4. The sync transmitting unit 4 outputs the sync signal for shutter glasses to the shutter glasses 10. It is preferable to transmit the sync signal for shutter glasses via a wireless communication using infrared, radio waves or the like. The shutter glasses 10 controls the switching of a left shutter and a right shutter of the shutter glasses 10 synchronizing with the display of the left image signal and the right image signal of the image display unit 5 according to the sync signal for shutter glasses received by the sync signal receiving unit 11.

### (Crosstalk Correction)

A crosstalk correction processing executed by the 3D image display apparatus 1 will be described.

In a case of correcting a left image signal, a crosstalk image that is seen mixing with a left image is calculated from a right image signal, and this crosstalk image signal is subtracted from the original signal of the left image. In the same manner, in a case of correcting a right image signal, a crosstalk image signal calculated from a left image signal is subtracted from the original signal of the right image. By subtracting a crosstalk image portion from an original image signal in advance, a crosstalk image is cancelled when a 3D image is observed.

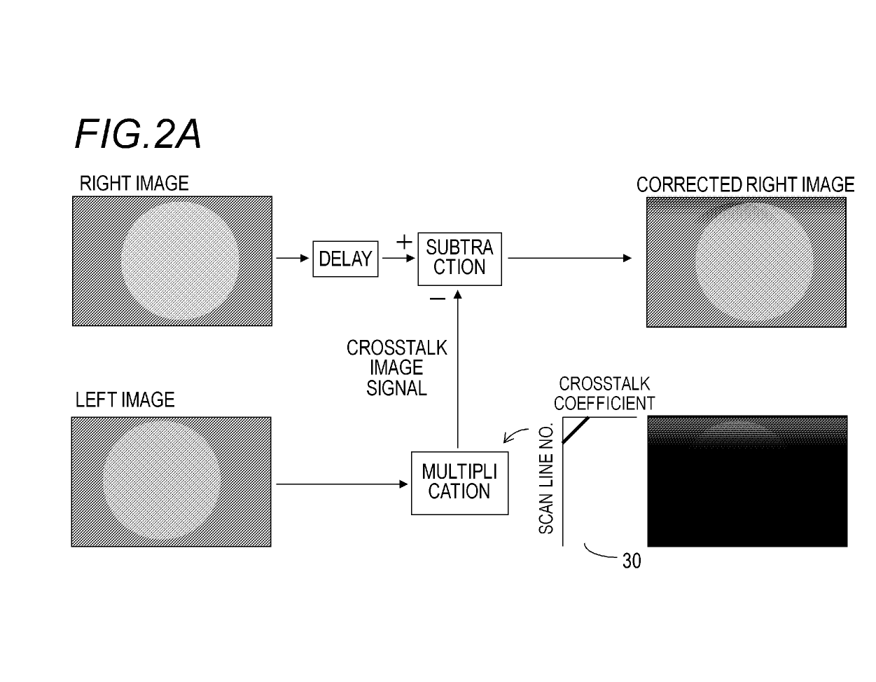

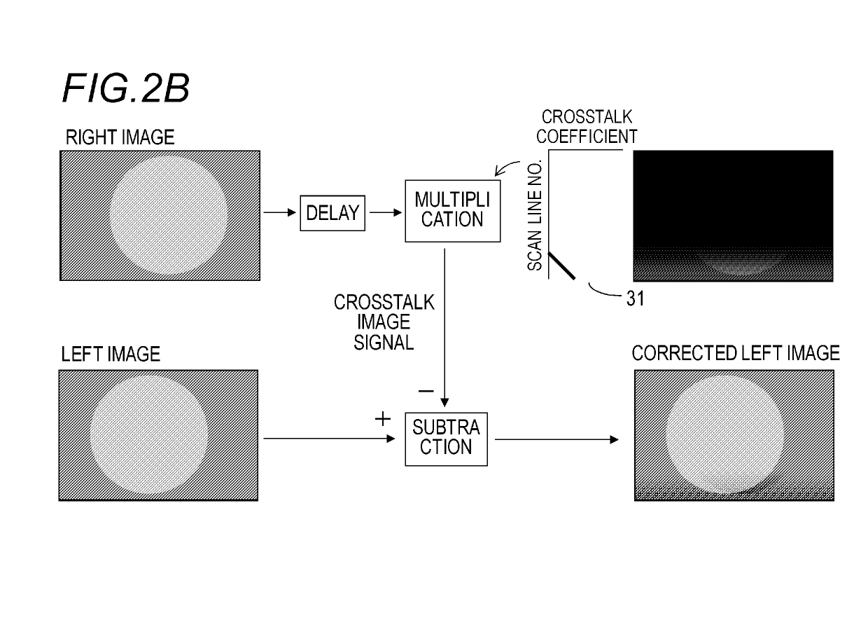

The crosstalk image signal is generated by the control unit 6 controlling the image signal processing unit 3. FIG. 2A and FIG. 2B show this generation method.

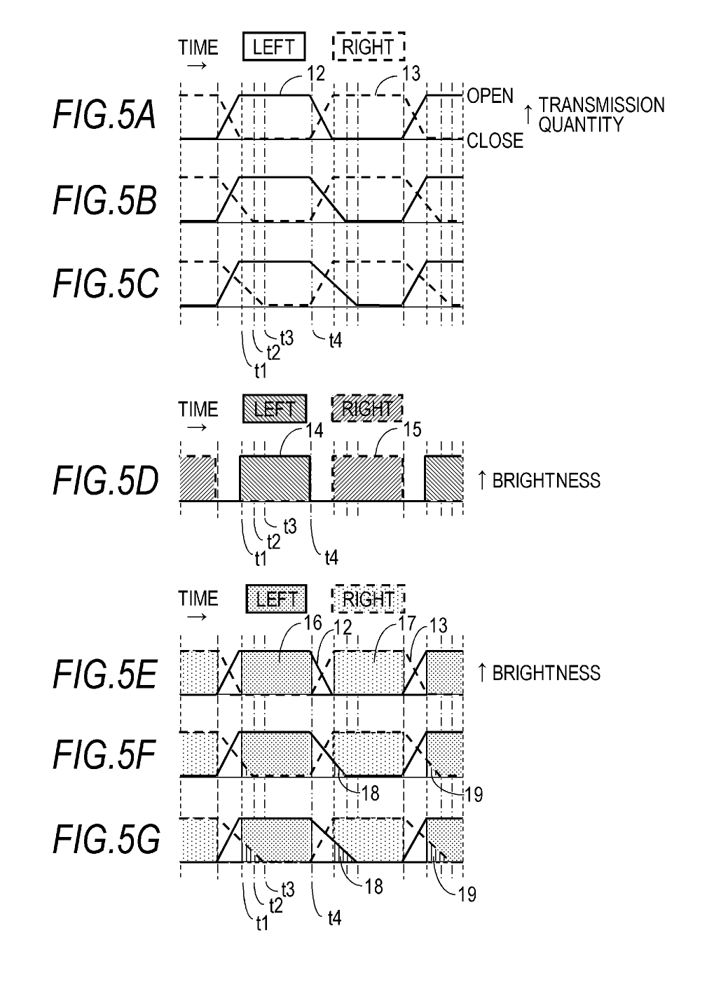

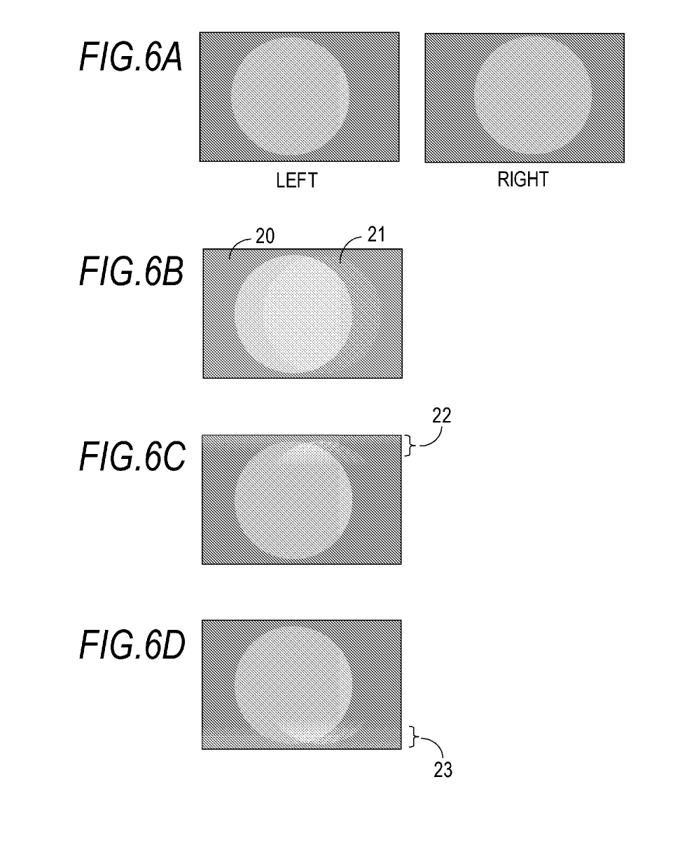

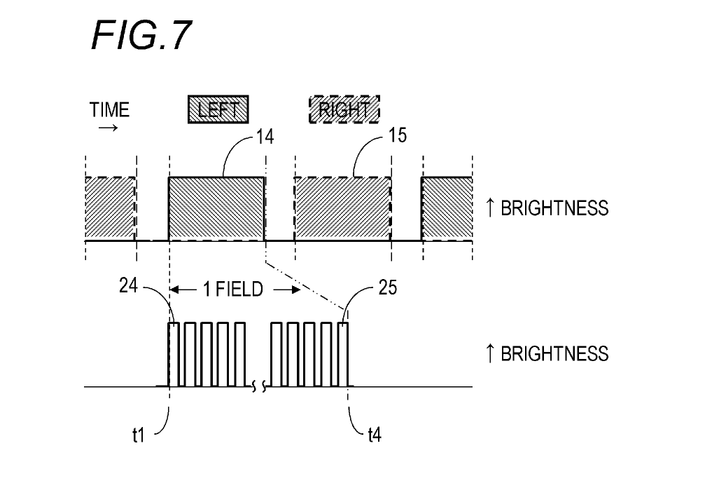

FIG. 2A shows a correction method when a part of an image of the subsequent display period is observed in an upper portion of the screen as a crosstalk image, as shown in FIG. 5F and FIG. 5G. Now an example of correcting a correction target right image signal using a left image signal in the subsequent display period will be described.

The control unit 6 reads a crosstalk coefficient table 30 from the storage unit 8, and transfers this information to the image signal processing unit 3. The crosstalk coefficient table is a table where a scan line (wiring) number (vertical position on the display screen) is associated with a crosstalk coefficient. The crosstalk coefficient is a value indicating a brightness ratio between the crosstalk image and the original image (that is, a ratio of brightness observed by the opposite eye as a crosstalk image), and is either measured or calculated from a response of the transmittance of the shutter glasses. The crosstalk coefficient is a real number, which is 0 or greater and less than 1. In the crosstalk coefficient table 30, a crosstalk coefficient of each scan line number is set so as to become sequentially smaller from the top, according to the vertical position on the display screen. The image signal processing unit 3 generates a crosstalk image signal by multiplying each row of the left image signal by a corresponding crosstalk coefficient. Then the image signal processing unit 3 generates a corrected right image signal by subtracting the crosstalk image signal from the right image signal which is one field period delayed. The frame memory 9 is used to delay the image signal.

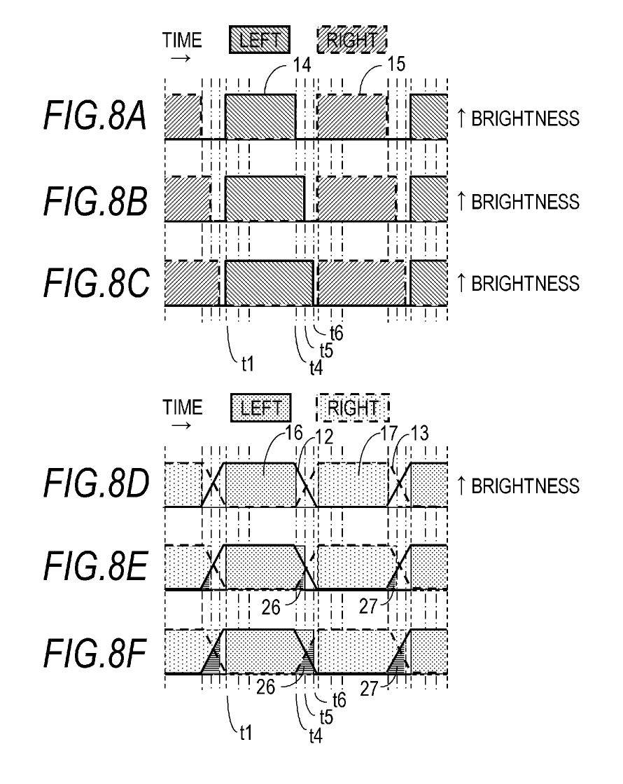

FIG. 2B shows a correction method when a part of an image of the previous display period is observed in a lower portion of the screen on a crosstalk image, as shown in FIG. 8E and FIG. 8F. Now an example of correcting a correction target left image signal using a right image signal in the previous display period will be described.

The control unit 6 reads a crosstalk coefficient table 31 from the storage unit 8, and transfers it to the image signal processing unit 3. In the crosstalk coefficient table 31 in this case, a crosstalk coefficient of each scan line number is set so as to become sequentially smaller from the bottom according to the vertical position on the display screen. The image signal processing unit 3 generates the crosstalk coefficient by multiplying each row of the right image signal, which is one field period delayed, by a corresponding crosstalk coefficient. Then the image signal processing unit 3 generates a corrected left image signal by subtracting the crosstalk image signal from the left image signal. The frame memory 9 is used to delay the image signal.

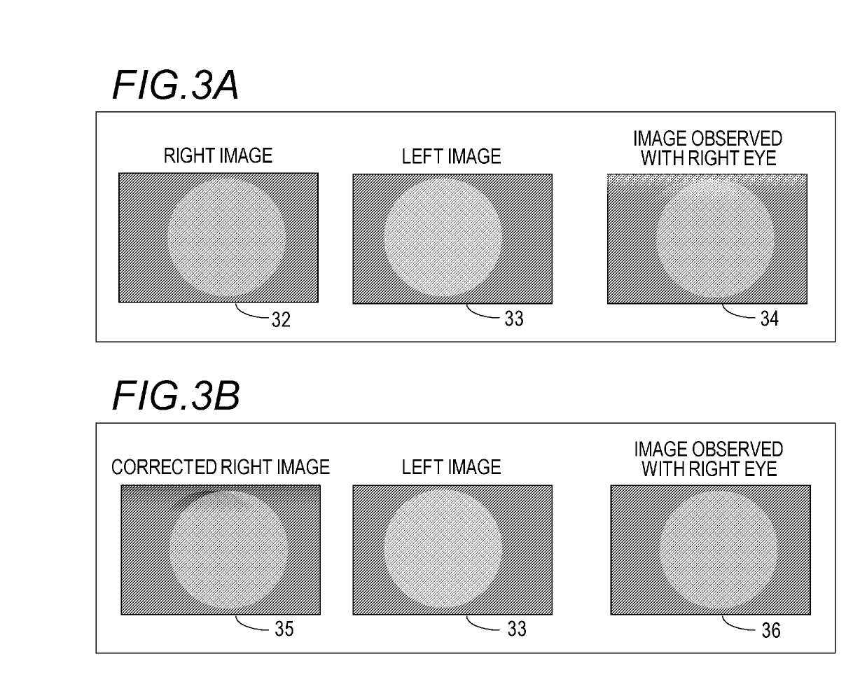

FIG. 3B shows an example of a result of a crosstalk correction. As FIG. 3A shows, if a right image 32 and a left image 33 are displayed without crosstalk correction, a crosstalk is observed in an upper portion of the screen with the right eye of the observer, as indicated by the reference number 34. If a crosstalk corrected right image 35 is displayed, as shown in FIG. 3B, on the other hand, an image 36 free of crosstalk is observed with the right eye, since the corrected portion (portion where brightness is dropped) of the right image 35 is visually cancelled by a crosstalk image generated from the left image 33.

It is common that the gamma processing matching the characteristics of a display is performed on image signals in advance. In the case of a gamma-processed image signal, the signal value is not in proportion to brightness. Therefore if a gamma-processed image signal is input, it is preferable that the image signal processing unit 3 first performs inverse gamma processing so that the input signal is converted into a signal in proportion to the brightness, and then performs the above mentioned crosstalk correction processing. Thereby the crosstalk can be corrected more accurately, and the quality of the 3D image can be improved. If an image signal in proportion to the brightness is input, the inverse gamma processing can be omitted.

According to the present embodiment, a value of the crosstalk coefficient is smaller than 1, and correlation of two image signals, which are adjacent to each other in the time direction, is high, therefore it is rare that the value of the crosstalk image signal becomes higher than the value of the correction target image signal. However there is still an exceptional occurrence where the value of the crosstalk image signal becomes higher than the value of the correction target image signal when scenes change, for example. In such a case, if the value of the crosstalk image signal is subtracted from the value of the correction target image signal, the value of the image signal becomes less than zero, and the image may be disturbed. To prevent this, it is preferable to dispose a limiter in the image signal processing unit 3, so that a value of the image signal after correction is set to zero if the value resulting from subtraction becomes less than zero (that is, if the value of the crosstalk image signal is greater than the value of the correction target image signal).

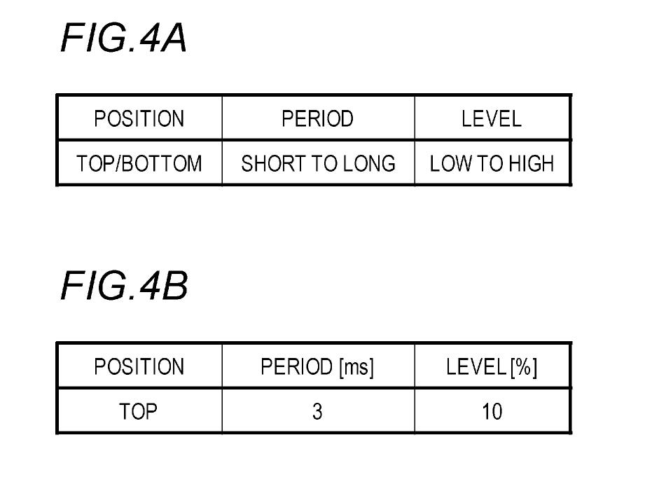

As mentioned above, it is preferable to store the crosstalk coefficient tables 30 and 31 in the storage unit 8 in the form of tables. The crosstalk coefficients may be stored in the approximate expressions (functions) in which the relationship between the delay characteristic of the shutter glasses or the scan line number and a coefficient is approximated by a straight line or a curved line. By using approximate expressions, the data size of the coefficients can be decreased. Data as shown in FIG. 4A and FIG. 4B may be set in the storage unit 8 in FIG. 1 in advance before the product is shipped from the factory. FIG. 4A and FIG. 4B are examples of characteristic data for crosstalk correction, which is stored in the storage unit 8 of the 3D image display apparatus 1, where FIG. 4A shows an outline of parameters, and FIG. 4B shows an actual example. “Position” is a parameter to indicate a vertical position on the screen, “top” means that crosstalk is generated in an upper portion of the screen, and “bottom” means that crosstalk is generated in a lower portion of the screen. “Period” is a parameter to indicate a period when the crosstalk image is observed (period in which the open state of the shutter could overlap with the display period of the previous or subsequent image signal). The length of the period corresponds to the width of the crosstalk image in the vertical direction. “Level” is a parameter to indicate the brightness ratio compared with a normal image. If the data shown in FIG. 4B is provided, it is preferable that the control unit 6 calculates the crosstalk coefficient of each scan line based on this data, generates the crosstalk coefficient table, and stores it in the storage unit 8. It is preferable that the user can set the crosstalk coefficient table and the data in FIG. 4B by operating the operation unit 7 in FIG. 1.

According to the crosstalk correction of the present embodiment described above, the crosstalk generated due to a delay of switching of the shutter glasses is decreased in the multiplex driving type display apparatus, so that a high quality 3D image is displayed. Since the cross-talk is decreased only by operating the image signals, it is unnecessary to decrease the display period of each image or to decrease the open period of the shutter glasses. Hence, a high quality 3D image, which has high brightness and less flickers, can be displayed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-112219, filed on May 14, 2010, which is hereby incorporated by reference herein in its entirety.

What is claimed is:

1. A 3D image control apparatus which causes a multiplex driving type display apparatus to display a right eye image and a left eye image alternately, comprising:
a correction unit for correcting an image signal to be output to the display apparatus in order to reduce crosstalk which is generated due to delay of switching of shutter glasses and is a phenomena of a part of the right eye image being observed with a left eye, or a part of the left eye image being observed with a right eye, wherein
the correction unit generates a crosstalk image signal by multiplying an image signal in a subsequent display period of a correction target image signal by a coefficient which is set corresponding to a vertical position on a display screen of the display apparatus in a descending order from the top, or multiplying an image signal in a previous display period of the correction target image signal by a coefficient which is set corresponding to the vertical position on the display screen in a descending order from the bottom, and subtracts the crosstalk image signal from the correction target image signal.

2. The 3D image control apparatus according to claim 1, wherein
if a value resulting from subtracting the crosstalk image signal from the correction target image signal is less than zero, the correction unit sets a value of the image signal after correction to zero.

3. The 3D image control apparatus according to claim 1, further comprising a storage unit for storing a table in which scan line numbers of the display apparatus are associated with the coefficients.

4. The 3D image control apparatus according to claim 1, further comprising an operation unit for a user to change the setting of the coefficients.

5. A 3D image control method executed by a 3D image control apparatus which causes a multiplex driving type display apparatus to display a right eye image and a left eye image alternately, comprising the steps of:
inputting an image signal including the right eye image and the left eye image; and
correcting an image signal to be output to the display apparatus in order to reduce crosstalk which is generated due to delay of switching of shutter glasses and is a phenomena of a part of the right eye image being observed with a left eye, or a part of the left eye image being observed with a right eye, wherein
in the step of correction, a crosstalk image signal is generated by multiplying an image signal in a subsequent display period of a correction target image signal by a coefficient which is set corresponding to a vertical position on a display screen of the display apparatus in a descending order from the top, or multiplying an image signal in a previous display period of the correction target image signal by a coefficient which is set corresponding to the vertical position on the display screen in a descending order from the bottom, and the crosstalk image signal is subtracted from the correction target image signal.
